(19) United States
(12) Patent Application Publication
(10) Pub. No.: US 2013/0283330 A1
(43) Pub. Date: Oct. 24, 2013

(54) ARCHITECTURE AND SYSTEM FOR GROUP VIDEO DISTRIBUTION

(71) Applicant: Thomas A. Hengeveld, Hollis, NH (US)

(72) Inventor: Thomas A. Hengeveld, Hollis, NH (US)

(73) Assignee: HARRIS CORPORATION, Melbourne, FL (US)

(21) Appl. No.: 13/449,361

(22) Filed: Apr. 18, 2012

(51) Int. Cl. H04N 7/173

(52) U.S. Cl. 725/116

(57) ABSTRACT

A method for managing distribution of video includes receiving a plurality of video data streams from a plurality of video data source devices associated with a group. Each video data stream includes a plurality of video frames and a plurality of metadata fields. The video data streams is parsed to extract the video frames and information comprising the plurality of metadata fields. A common group metadata stream is generated which includes metadata information from the plurality of metadata fields. The common group metadata stream is communicated to user equipment devices (UEDs) operated by users who may have an interest in video streams. Upon receipt of a demand for a first user video stream based on information contained in the common group metadata stream, a first user video stream is generated and communicates to a UED.

### BACKGROUND OF THE INVENTION

1. Statement of the Technical Field

The inventive arrangements relate to public safety communication systems, and more particularly to video distribution in group-based communication environments.

2. Description of the Related Art

In public safety voice systems, it is common for users to be partitioned into talk groups. Within each group a single talker “has the floor,” and other members of the group hear the talker more or less simultaneously. These systems work well for voice communications, but similar progress has not been made in relation to determining optimal systems and methods for distributing video content.

It is known that humans process speech information in ways that are dramatically different as compared to the ways in which they process visual information. Colloquially, one might observe that people are accustomed to listening to one speaker at a time. In formal committee meetings, a chairman or facilitator arbitrates between competing calls for the floor, and enforces sequential communication. Every member of the committee hears the same thing. In contrast to human perceptions of speech, visual perception is high-speed and episodic. In fact, the “fixation point” of the eye moves an average of three times per second, a period during which only two phonemes are typically produced in human speech. For example, our ability to rapidly shift our visual focus has led to surveillance systems where a single person monitors multiple images continuously.

Whereas speech is best consumed sequentially, visual stimulus (i.e. video) can be understood simultaneously. Also, there are fundamental differences in the ways that members of the same group experience visual vs. auditory stimulus, and in the way individuals process simultaneous stimuli. Thus, while arbitrated group voice communication paradigms with sequential floor control are dominant in critical communications (especially public safety voice systems) optimal methods for distribution of group video information are less apparent. Moreover, while many video conferencing systems and methods are known in the art, none of these conventional systems satisfy the needs and requirements of users in a group communication context.

### SUMMARY OF THE INVENTION

Embodiments of the invention concern methods for managing distribution of video media in a group setting. The methods include receiving at a group server a plurality of video data streams each respectively generated in a plurality of video data source devices associated with a group. Each video data stream includes a plurality of video frames and a plurality of metadata fields. A computer processor at the group server parses the video data streams for extracting the video frames and information comprising the plurality of metadata fields. The group server generates a common group metadata stream which selectively includes metadata information from each of the plurality of metadata fields. The common group metadata stream is communicated to user equipment devices (UEDs) operated by users who may have an interest in video streams provided from the video data source devices. Software on the UED monitors the group metadata, and based on mission specific criteria, determines whether the human user should monitor the video stream. If the software determines that the user should monitor the video stream, the group server will receive from at least one of the UEDs, a demand for a first user video stream. The demand for the first user stream is based on information contained in the common group metadata stream. In response to the demand, the group server generates the first user video stream comprising the plurality of video frames included in one of the video data streams. The first user video stream is then communicated to the UED from which the demand was received. The method can also include receiving from at least one of the UEDs, a conditional demand for a first user video stream and communicating the first user video stream to the UED based on such conditional demand. The conditional demand can specify certain processing action to be performed by the computer processor prior to communicating the user video stream to said UED. The foregoing methods can also be implemented as a computer system for managing distribution of video media in a group setting.

### BRIEF DESCRIPTION OF THE DRAWINGS

Embodiments will be described with reference to the following drawing figures, in which like numerals represent like items throughout the figures, and in which:

FIG. 1 is a conceptual diagram which is useful for understanding how video streams can be distributed in group setting.

FIG. 2 is a flowchart which is useful for understanding the operations of a group function which executes in a group video server.

FIG. 3 is a conceptual diagram which is useful for understanding how video streams from multiple groups can be distributed to users in a police patrol scenario.

FIG. 4 is a flowchart that is useful for understanding the operations of user equipment in a group video distribution system.

FIG. 5 is a computer architectural diagram that is useful for understanding an implementation of a group video distribution system

FIG. 6 is a block diagram that is useful for understanding the architecture of an exemplary user equipment device.

FIG. 7 is a block diagram that is useful for understanding the architecture of an exemplary group server.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

The present invention concerns a system and method for video distribution in scenarios where users are partitioned into groups for purposes of communicating and carrying out a particular mission. It is common for users to be partitioned into groups in order to facilitate certain types of voice communication systems. For example, in a trunked radio system environment, a plurality of users comprising a certain group may be assigned to a “talk group” that uses two or more frequencies to facilitate communications among the group. In such systems the phrase talk group is often used to refer to a virtual radio channel that members of a group will use to communicate with one another. Talk groups are well known in the art and therefore will not be described here in detail.

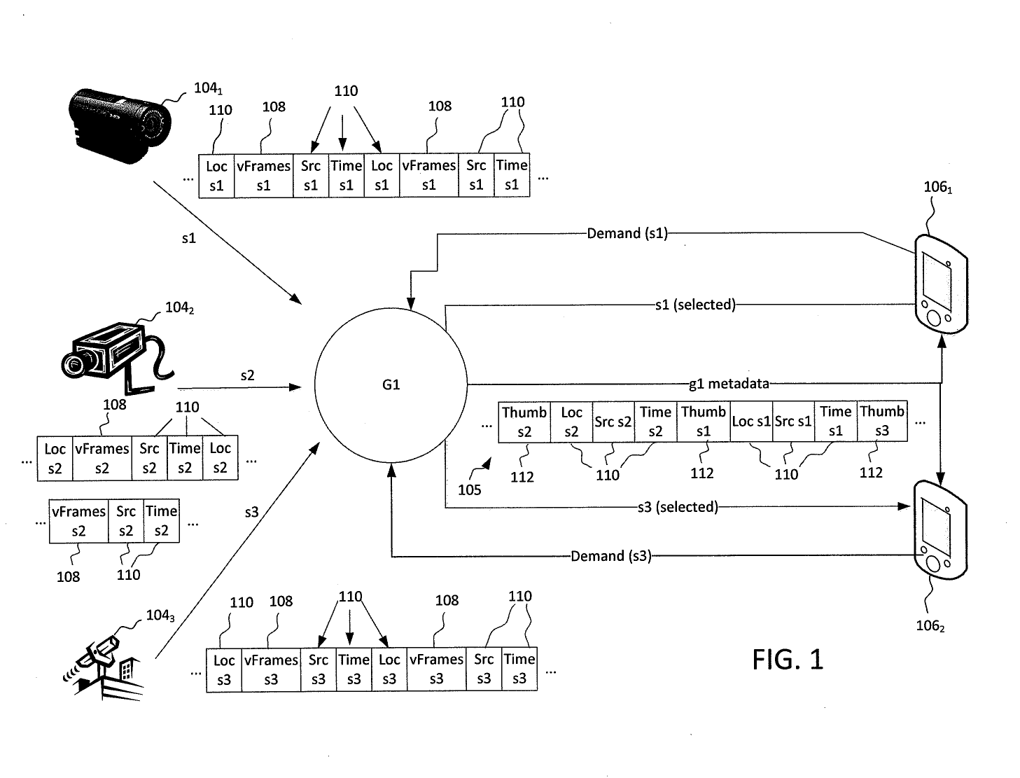

Members of a group, such as a talk group, will generally have a common command and control structure, but are often each focused on different activities or different specific incidents at any particular time. Accordingly, video distribution in such an environment is advantageously arranged so that video streams are selectively communicated when and where they will be of interest to users. Referring now to FIG. 1 there is illustrated a model for group video distribution that advantageously facilitates each of these objectives. The model involves a plurality of user equipment devices (UEDs) 106₁, 106₂. Only two UEDs are shown in FIG. 1 for purposes of describing the invention; but it should be understood that the invention is not limited in this regard. Each of the UEDs can be configured to include a display screen on which users can view video streams which have been communicated to each device. In some embodiments, the UEDs can also be configured to facilitate voice communications, including voice communications within a talk group as may be facilitated by a trunked radio communications environment.

A plurality of video streams s1, s2 and s3 are generated by a plurality of video sources 104₁, 104₂, 104₃, respectively. Each of the video streams is comprised of video frames 108 and a plurality of fields or elements containing metadata 110. In the example shown, the metadata includes source information (Src) specifying a name or identification for the source of the video frames 108, a Time when the video frames 108 were captured, and location information (Loc) specifying a location of the source when the video frames were captured. The metadata shown in FIG. 1 is merely exemplary in nature and not intended to limit the types of metadata that can be included with the video streams s1, s2 and S3. Instead, many different types of metadata can be included in the video data streams, and the advantages of such different types of metadata will become apparent as the discussion progresses. As used herein, metadata can include any type of element or field (other than video frames) containing information about the video frame, or the conditions under which they were created. Metadata can also include data relating to activities, actions, or conditions occurring contemporaneously to capturing associated video frames, regardless of whether such information directly concerns the video frames.

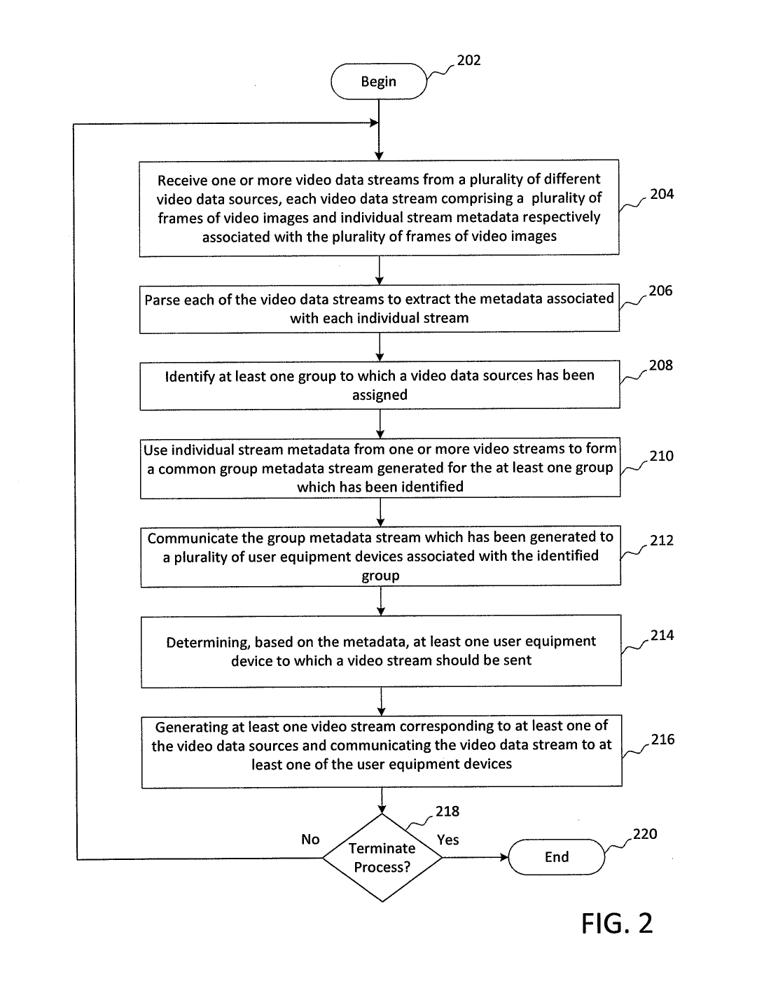

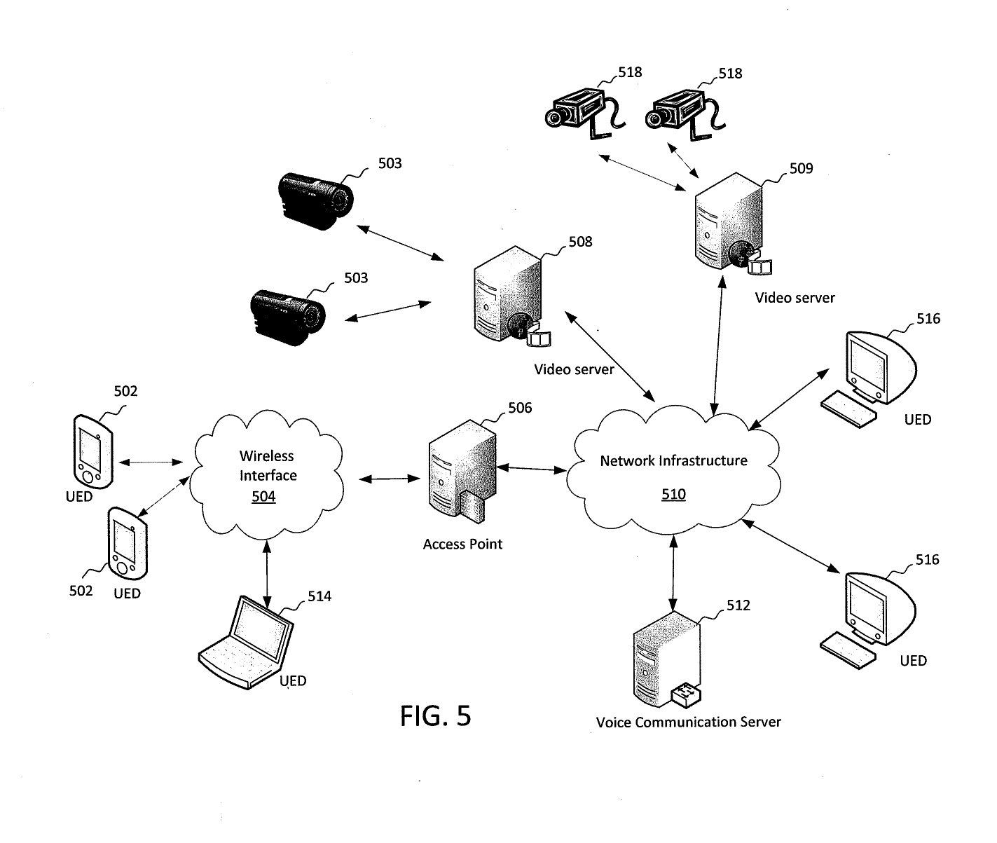

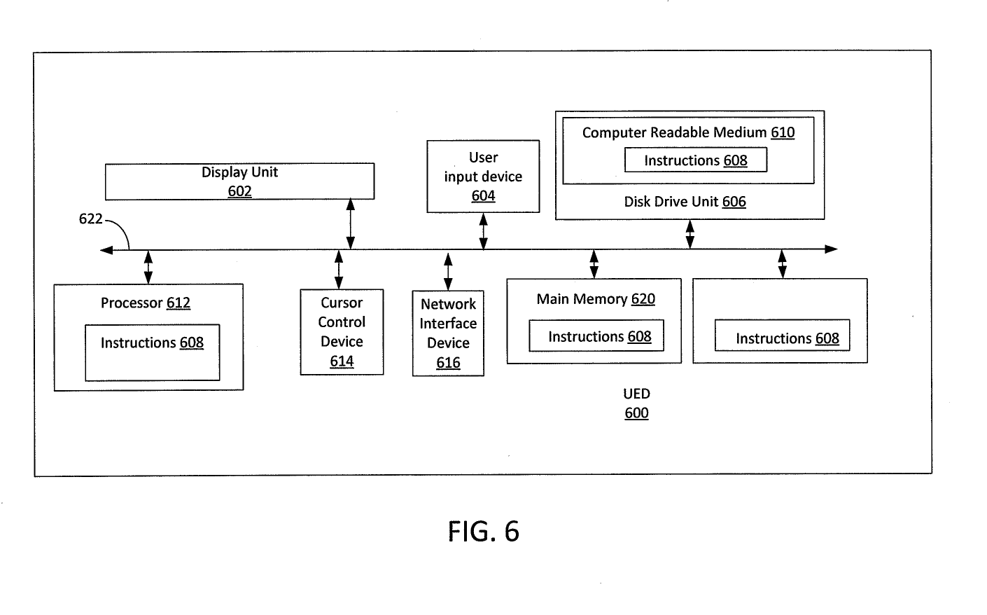

Each of the video data streams are communicated from the sources 104₁, 104₂, 104₃ to a group function G1. The group function can be implemented in hardware, software, or a combination of hardware and software. For example, the group function can be a software application executing on a group server as described in FIGS. 5 and 6. Referring now to FIG. 2, there is provided a flowchart in which the operation of group function G1 is described in further detail. The process begins at 202 and continues at 204, in which the group function receives one or more of the video data streams s1, s2, s3 from the video data sources. Thereafter, the group function parses each of the received video data streams to extract the metadata associated with each individual stream.

In step 208, the group function identifies at least one group to which a video data source 104₁, 104₂, 104₃ has been allocated or assigned. In a preferred embodiment, groups are pre-defined so that the group function has access to a table or database that identifies which video data sources are associated with a particular group. For example, video data sources 104₁, 104₂, 104₃ can be identified as belonging to a common group. Alternatively, the various video data sources can be allocated to more than one group. Also, it is possible for an individual source to be allocated or assigned to more than one group. For example, source 104₁ could be associated with a first group, source 104₂ could be associated with a second group, and source 104₃ could be associated with both groups. If there exists a group to which one or more of the video data sources have been allocated, the group function generates in step 210 a group metadata stream for that group. Alternately, the membership of a source in a particular group may be managed dynamically by the source, or by another entity. For example, if a source is associated with a particular police officer, the source could change groups synchronous with the police officer changing talk groups (i.e. group membership follows command and control structure).

If more than one video data stream is actively being received by the group function, then step 210 can optionally include selectively commutating a plurality of individual stream fields of metadata 110 from the appropriate streams (s1, s2, s3) into a common group metadata stream for a particular group. In the example shown in FIG. 1, we assume that video data sources 104₁, 104₂, 104₃ are associated with a common group. Accordingly, individual stream metadata for streams s1, s2, and s3 can be commutated into a common group metadata stream (g1 metadata).

As used herein, the term “commutated” generally refers to the idea that metadata associated with each individual data stream is combined in a common data stream. A single data stream can be used for this purpose as shown, although the invention is not limited in this regard and multiple data streams are also possible. If the individual stream metadata is combined in a common data stream, it can be combined or commutated in accordance with some pre-defined pattern. This concept is illustrated in FIG. 1, which shows a group metadata stream (g1 metadata) which alternately includes groups of metadata relating to s1, s2, and s3. Still, it should be understood that the invention is not limited in this regard and other commutation schemes are also possible in which metadata from each video data stream is combined or commutated in different ways within a common group metadata stream. Also, such common group metadata can be communicated over one or more physical or logical channels. Ultimately, all that is required is that the parsed metadata from the selected video data sources be collected and then communicated to a plurality of UEDs as hereinafter described. In FIG. 1, an exemplary group metadata stream (g1 metadata) 105 includes all of the various types of metadata from each of the individual video data streams, but it should be understood that the invention is not limited in this regard. Instead, the group metadata stream can, in some embodiments, include only selected types of the metadata 110. Moreover, if bandwidth limitations are a concern, one or more of the fields of metadata 110 can be periodically omitted from the common group metadata to reduce the overall data volume. Alternatively, certain types of metadata can be included in the group metadata only when a change is detected in such metadata by the group function G1.

The group metadata stream (g1 metadata) 105 can be exclusively comprised of the plurality of fields of metadata 110 as such fields are included within the video data streams s1, s2, or s3. However, the invention is not limited in this regard. In some embodiments, the group function G1 can perform additional processing based on the content of the metadata 110 to generate secondary metadata which can also be included within the group metadata stream. For example, the group function G1 could process location metadata (Loc) to compute a speed of a vehicle in which a source 104₁, 104₂, 104₃ is located. The vehicle speed information could then be included within the group metadata stream as secondary metadata associated with a particular one of the individual video data streams s1, s2, and s3. Similarly, the common group metadata generally will not include the video frames 108, but can optionally include thumbnail image data 112 which can be thought of as a kind of secondary metadata. Thumbnail image data 112 can comprise a single (still) image of a scene contained in the video stream and is provided instead of the streaming video. An advantage of such an approach is that such thumbnail image data 112 would require significantly less bandwidth as compared to full streaming video.

The thumbnail image data can also be especially useful in situations in which a UED user has an interest in some aspect of a video stream, but finds it advantageous to use automated processing functions to provide assistance in monitoring such video stream. In such a scenario, the automated processing functions are preferably performed at a server on which group function G1 is implemented. It is advantageous to perform such automated processing of the video stream at G1 (rather than at the UED) since fixed processing resources generally have more processing power as compared to a UED. Moreover, it can be preferable not to burden the communication link between G1 and the UED with a video stream for purposes of facilitating such automated processing at the UED. In such a scenario, a user can advantageously select or mark portions of the thumbnail image, and then cause the UED to signal or send a message to the group function G1 indicating that certain processing is to be performed at G1 for that portion of the video stream.

An example of a situation which would require such processing by the group function would be one in which a user of a UED is interested in observing a video stream only if a certain event occurs (e.g. movement is detected or a person passes through a doorway). The user could use a pointing device (e.g. a touchpad) of the UED to select or mark a portion of the thumbnail image. The user could mark the entire image or select some lesser part of the image (e.g. the user marks the doorway area of the thumbnail). The user could then cause the UED to send a message to G1 that the video stream corresponding to the thumbnail is to be communicated to the UED only when there is movement at the selected area. For example, the message could identify the particular thumbnail image, the portion selected or marked by the user, and the requested processing and/or action to be performed when motion is detected. The group function G1 would then perform processing of the video stream received from the source to determine when movement is detected in the selected portion of the video image. The detection of movement (e.g. a person entering or exiting through a doorway), by the group function could then be used to trigger some action (e.g. communicating the corresponding video stream to the user). Of course, the invention is not limited in this regard and other actions could also be triggered as a result of such video image processing. For example, the image could also be enhanced in some way by G1 or G1 could cause the video stream to play back in reverse chronological order to provide a rewind function.

The foregoing features have been described in a context which involves utilizing a thumbnail image, but those skilled in the art will appreciate that a thumbnail image is not necessarily required for all embodiments as described herein. For example, a thumbnail image is not required if a video stream is to be played back in reverse, or the entire scene represented by a video stream is to be processed by the group function without regard to any user selection of a selected portion thereof.

In step 212, the group metadata stream for at least one group is communicated to a plurality of UEDs that are associated with that group. For example, FIG. 1 shows that the group metadata stream (g1 metadata) is communicated to UEDs 106₁, 106₂. The group metadata stream can be communicated continuously or periodically, depending on the specific implementation selected.

In step 214 a determination is made regarding at least one UED to which a video stream should be communicated. This determination can be made at the group function, at the UED or both. In some embodiments, the group function G1 will evaluate one or more fields or elements of metadata 110 to identify a UED to which a video stream s1, s2, s3 should be provided. Alternatively, or in addition thereto, the UEDs will monitor the group metadata stream to identify when a particular video data stream s1, s2, or s3 may be of interest to a particular user. When one or more conditions exist to indicate that a particular video data stream may be of interest to a user of a particular UED, a message can be communicated from the UED to the group function G1 indicating that a particular video data stream is selected. The video stream is one that is specifically selected by or for a user of a particular UED. Accordingly, this video stream is sometimes referred to herein as a user video stream. In step 214, the group function receives the message comprising a user selection of a video data source or user video data stream. In either scenario, the group function responds in step 216 by generating an appropriate user video stream and communicating same to the UED. For example, the user video stream that is communicated can be comprised of vFrames 108 which have been parsed from a selected video data stream. In step 218, the group function checks to determine if the process has been instructed to terminate. If so (218: Yes), then the process ends in step 220. Alternatively, if the process has not been terminated (218: No) then the process returns to step 204.

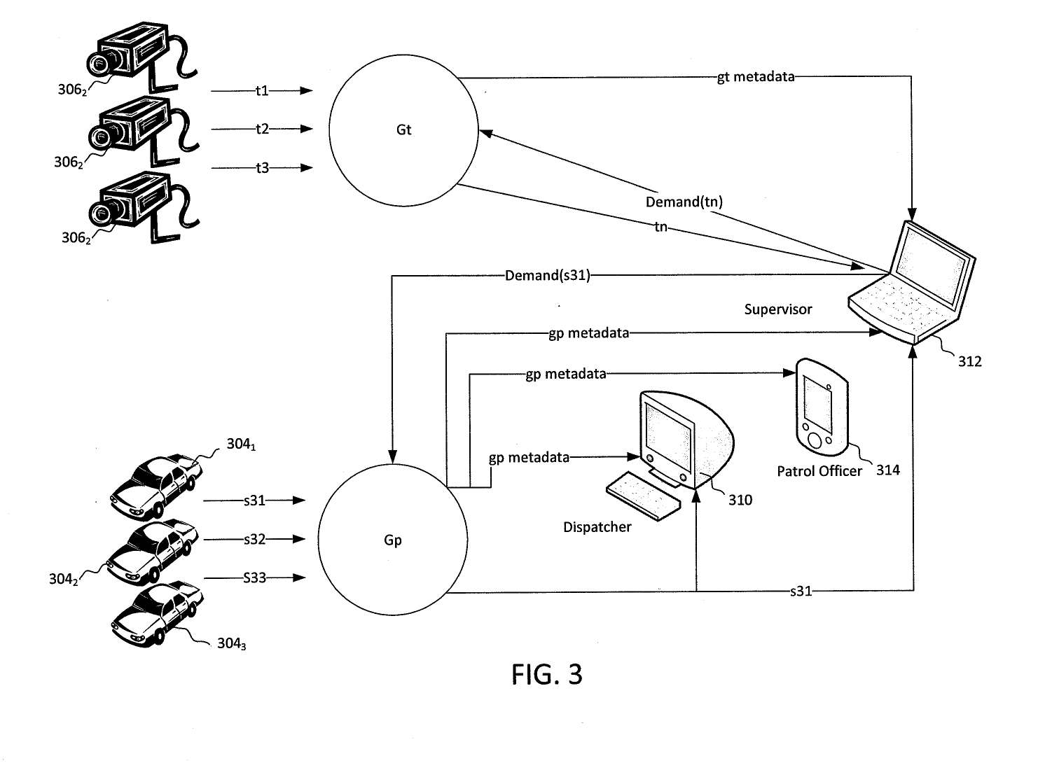

In order to more fully appreciate the advantages of the foregoing methods, a exemplary embodiment is described with reference to FIG. 3. In this example we assume that a police patrol group has a supervisor, a dispatcher, and a number of patrol units 304₁, 304₂, 304₃. Conventional police patrol cars can include a front focused video camera that records to a trunk-mounted media storage device. The front focused video camera generates a video stream that can be transmitted over a broadband network. For purposes of this example, we shall assume that these front focused video cameras are video sources for the patrol group, and that these video sources generate video streams s31, s32 and s33. These video streams can be communicated to a group function Gp. In addition, we assume a “traffic camera” group that is continually sending video from traffic cameras to a group function (Gt). Group functions Gp and Gt generate group metadata streams in a manner similar to that described above with respect to group function G1.

Normally, no video is transmitted from the patrol units 304₁, 304₂, 304₃ unless certain predetermined conditions (e.g. a traffic stop, or a high speed chase) occur. When no video is being transmitted from the patrol units, the group metadata stream (gp metadata) is essentially idle. Assume that a traffic stop is initiated such that a patrol unit (e.g. patrol unit 304₁) begins transmitting a video stream (s31) to the group function Gp. In response, the group function Gp begins sending a group metadata stream (gp metadata) to each of the UEDs associated with the group. The group metadata stream includes metadata from the s31 video stream (and any other video streams that are active). In this example, the UEDs that are associated with the group include a dispatcher's console 310, a patrol supervisor's computer 312, and a patrol unit UED 314. The metadata is analyzed at the group function Gp and/or at the UEDs 310, 312, 314. At the UED, the analysis can comprise an evaluation by the user of certain information communicated in the metadata. Alternatively, the evaluation can be a programmed algorithm or set of rules which automatically processes the group metadata to determine its relevance to a particular user. Based on such analysis a demand or request can be made for a particular video stream.

According to a preferred embodiment, the group metadata stream contains one or more types of metadata that are useful for determining whether a particular video stream will be of interest to various members of the group. The particular types of metadata element included for this purpose will depend on the specific application. Accordingly, the invention is not limited in this regard. For example, in the police patrol example in FIG. 3, the metadata can include one or more of a vehicle identification, a time associated with the acquisition of associated video frames, vehicle location, vehicle speed, the condition of emergency lights/siren on the vehicle (i.e. whether emergency lights/siren are on/off), the presence/absence of a patrolman from a vehicle, PTT status of a microphone used for voice communication, airbag deployment status, and so on.

If the metadata is analyzed at the UED, the it can be processed and the information represented by such metadata can be displayed on a screen of the UED. In some embodiments the user can evaluate this information to determine their interest in a video stream associated with such metadata. In other embodiments, the UED can be programmed to automatically display a video stream when one or more of the metadata elements satisfy certain conditions. The conditions selected for triggering the display of a video stream can be different for different users. Accordingly, UEDs assigned to various users can be programmed to display a video stream under different conditions. Various rules or algorithms can be provided for triggering the display of a video data stream. In some embodiments, selectable user profiles can be provided at each UED to allow each user to specify their role in a group. In such embodiments, the user profile can define a set of rules or conditions under which a video stream is to be displayed to the user, based on received metadata.

Referring once again to FIG. 3, assume that metadata for a particular video stream s31 indicates that the video stream will be of interest to the group dispatcher. Such conditions might occur, for example, when the metadata indicates that a particular patrol vehicle is engaged in a traffic stop. Based on such metadata, the group function Gp can determine that the video stream s31 should be communicated to the dispatcher UED 310. Accordingly, the group function Gp will generate a user video stream corresponding to video frames received from patrol vehicle 304₁. The user video stream is automatically communicated to the dispatcher's console 310 because it is known that a dispatcher has an interest in observing conditions at the traffic stop. When the user video stream is received at the dispatcher's console 310, the dispatcher can be alerted to its availability, or the video stream can be automatically displayed for the dispatcher. Concurrently with these actions, the group function will communicate a group metadata stream (gp metadata) to each of the UEDs (310, 312, 314) in the group. The group metadata stream will include individual stream metadata from stream s31. When such group stream metadata is received at the supervisor's UED 312, it can be used to alert that supervisor to the occurrence of the traffic stop. In this example we assume that the supervisor is not interested in observing a routine traffic stop, and the video stream s31 is therefore not manually requested by the patrol supervisor. Also, since patrol supervisors are not generally interested in observing routine traffic stops, the metadata processing algorithm on his UED 312 does not make an automatic request that the video stream s31 be communicated to the supervisor's UED.

Assume that the routine traffic stop transitions to a situation involving a pursuit of a suspect's vehicle. Under those circumstances, the patrol supervisor may suddenly have an interest in observing the video stream associated with such event. The patrol supervisor can become aware of the existence of the pursuit as a result of monitoring voice communications involving the group. Alternatively, one or more fields or elements of metadata 110 associated with video data stream s31 can be suggest that a pursuit is in progress. For example, metadata 110 indicating the patrol vehicle is traveling at high speed and with emergency lights enabled can serve as an indication that a pursuit is in progress. The UED can process the metadata to determine that a condition exists which is likely to be of interest to the patrol supervisor. Accordingly, the supervisor's UED 312 can be programmed to automatically request that video stream s31 be communicated to it. Alternatively, the metadata information indicating a pursuit in progress can be displayed to the patrol supervisor, causing the patrol supervisor to request the associated video stream s31. In either case, a request (Demand(s31)) is communicated to the group function Gp for the associated video stream. Upon receiving such request, group function Gp communicates video frames associated with video stream s31 to the UED 312 as a user video stream.

One or more members of a group can also receive at least a second stream of group metadata from a second group function. For example, in the example shown in FIG. 3, a group supervisor's UED 312 can receive a second stream of group metadata (gt metadata) from group function Gt. In this example group function Gt processes video streams t1, t2 and t3 received from a group of traffic cameras 306₁, 306₂, 306₃. The group function Gt generates group metadata (gt metadata) in a manner similar to group function Gp. In this scenario, the metadata from the traffic cameras includes their location, and thumbnail images as previously described. A software application executing on the supervisor's UED 312 can monitor the metadata from Gp, recognize the pursuit scenario described above based on such metadata, and display the patrol car video stream s31 as previously described. According to a further embodiment of the invention, the software application execution on UED 312 can use the location metadata associated with video data stream s31 to determine traffic-camera video streams that are relevant to the pursuit. Based on such determination, the UED 312 can automatically request (Demand(tn)) one or more appropriate traffic camera video streams to from the group function Gt. Upon receipt of such video stream at UED 312, the video stream(s) can be automatically displayed at UED 312, along with the video stream from the patrol car in pursuit. Similarly, it is likely that the general traffic conditions at a moderate distance from the pursuit may be relevant to the supervisor's judgment. One can imagine that in these circumstances, periodic “snapshots” rather than streaming video might be suitable. Accordingly, thumbnail images included in the group metadata stream could be displayed on UED 312 in place of streaming video for certain traffic cameras. Because such thumbnail images are still or snapshot images, they would have a significantly lower bandwidth requirement than full streaming video.

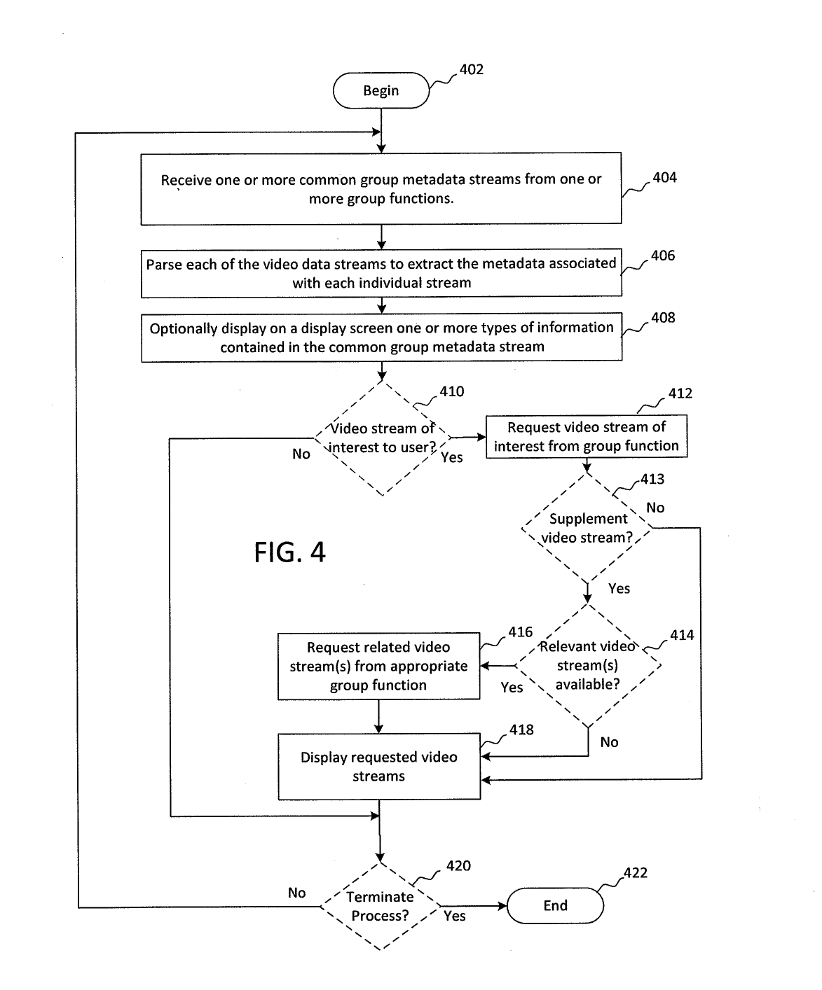

Turning now to FIG. 4, there is a flowchart that is useful for understanding the operation of one or more UEDs. The process can begin in step 402 and continues to step 404. In step 404 a UED receives one or more common group metadata streams from one or more group functions. In step 406 one or more types of information contained in the common group metadata stream are optionally processed and displayed for a user in a graphical user interface. Such information can include a direct presentation of the metadata information (e.g. patrol vehicle location displayed on screen) or vehicle status information reports that are derived from metadata (e.g. status is patrolling, traffic stop in progress, or patrol vehicle in pursuit). In step 410 the UED can determine (based on received metadata) whether any particular video stream is of interest to a user. As previously described, this determination can be made based on the application of one or more preprogrammed rules that specify the conditions under which particular video streams are of interest to a user. Accordingly, the UED parses the group metadata stream and analyzes the metadata for each stream to identify one or more streams of interest.

If at least one video is of interest to a particular user (410: Yes) then the process continues to step 412 where the one or more video streams is requested from one or more of the group functions (e.g. Gp, Gt). Thereafter, the process continues to step 413 where a determination is made as to whether the video stream of interest should be supplemented with additional streams of related video streams that may be relevant to the user. A determination in step 413 will depend upon a variety of factors which may vary in accordance with a particular implementation. For example, these factors can include the source identity of the video stream selected, and the reason(s) why that particular video stream was deemed to be of interest to a user, and whether the additional video streams will provide relevant information pertaining to a selected video stream. For example, consider the case where the video source is a patrol vehicle front mounted camera, and the video stream is selected for display because the metadata suggests a pursuit involving that patrol vehicle. In such a scenario, one or more traffic camera video streams may be relevant to the user. Conversely, consider the case where the metadata for a video stream indicates that the video source is a patrol vehicle front mounted video camera, but the video stream is selected because the metadata indicates that a traffic stop is in progress. In such a scenario, the benefit of displaying video streams from traffic cameras in the area may be minimal. Accordingly, a determination could be made in this instance that a supplemental video stream is not necessary or desirable.

If a determination is made that it would be advantageous to supplement a selected video stream with one or more additional video streams, then the process continues on to step 414. In this step, a determination is made as to whether there are related video streams available that are relevant to the video stream which has been selected. This step can also involve evaluating metadata associated with a particular stream to identify relevant video streams. For example consider again the pursuit scenario described above. The location metadata from the video stream provided by the patrol vehicle could be accessed to determine an approximate location of the patrol vehicle. A determination could then be made in step 414 as to whether there were any traffic cameras located within some predetermined distance of the patrol vehicle's current location. Of course, the invention is not limited in this regard and other embodiments are also possible. If relevant video streams are available, they are requested in step 416. In step 418, additional processing can be performed for displaying the requested video streams. In step 420, a determination is made as to whether the process 400 should be terminated. If so, the process terminates in step 422. Otherwise the process continues at step 404.

Referring now to FIG. 5, there is illustrated a computer architecture that is useful for understanding the methods and systems described herein for group distribution of video streams. The computer architecture can include a plurality of UEDs. For example, a plurality of portable UEDS 502, 514 are in communication with a network infrastructure 510 using a wireless interface 504 and access point server 506. Alternatively, or in addition to UEDs 502, 514, a plurality of UEDs 516 can communicate with the network infrastructure directly via wired connections. A plurality of video cameras 503, 518 can serve as sources for video streams. The video cameras communicate video data streams to video servers 508, 509. The data can be communicated by wired or wireless infrastructure. In some embodiments, the wireless interface 504 and/or network infrastructure 510 can be used for this purpose, but the invention is not limited in this regard. For example, it can be preferable in some embodiments for video streams to be communicated to servers 508, 509 by a separate air interface and network infrastructure.

Video cameras 503, 518 communicate video data streams (including metadata) to a respective group video server 508, 509. Each video server is programmed with a set of instructions for performing activities associated with a group function (e.g., G1, Gp, Gt) as described herein. Alternatively, a single server can be programmed to perform activities for facilitating activities associated with a plurality of said group functions. Accordingly, the video servers 508, 509 parse the video data streams and generate common group metadata streams as previously described. The common group metadata streams are then communicated to one or more of the UEDs 502, 514, 516 by way of network infrastructure 510 and/or wireless interface 504. Requests or demands for video streams are generated at the UEDs based on human or machine analysis of the common group metadata stream. Such requests are sent to the video servers 508 and/or 509 using wireless interface 504 and/or network infrastructure 510. In response to such requests, video streams are communicated to UED from the video servers. In some embodiments, the video servers 508, 509 can also analyze the metadata contained in received video streams to determine if a video stream should be sent to a particular UED.

The present invention can take the form of a computer program product on a computer-usable storage medium (for example, a hard disk or a CD-ROM). The computer-readable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

The methods described herein can be performed on various types of computer systems and devices, including a server computer, a client user computer, a personal computer (PC), a tablet PC, a laptop computer, a desktop computer, or any other device capable of executing a set of instructions (sequential or otherwise) that specifies actions to be taken by that device. Further, while some of the steps involve a single computer, the phrase “computer system” shall be understood to also include any collection of computing devices that individually or jointly execute a set (or multiple sets) of instructions to perform any one or more of the methodologies discussed herein.

Referring now to FIG. 6, there is provided an exemplary UED 600 that is useful for understanding the invention. The UED 600 includes a processor 612 (such as a central processing unit (CPU), a graphics processing unit (GPU, or both), a disk drive unit 606, a main memory 620 and a static memory 618, which communicate with each other via a bus 622. The UED 600 can further include a display unit 602, such as a video display (e.g., a liquid crystal display or LCD), a flat panel, a solid state display, or a cathode ray tube (CRT)). The UED 600 can include a user input device 604 (e.g., a keyboard), a cursor control device 614 (e.g., a mouse) and a network interface device 616. Network interface device 716 provide network communications with respect to network infrastructure 504, 510. In the case of UEDs 502 which communicate wirelessly, the network interface device 616 can include a wireless transceiver (not shown) as necessary to communicate with wireless interface 504.

The disk drive unit 606 includes a computer-readable storage medium 610 on which is stored one or more sets of instructions 608 (e.g., software code) configured to implement one or more of the methodologies, procedures, or functions described herein. The instructions 608 can also reside, completely or at least partially, within the main memory 620, the static memory 618, and/or within the processor 612 during execution thereof by the computer system. The main memory 620 and the processor 612 also can constitute machine-readable media.

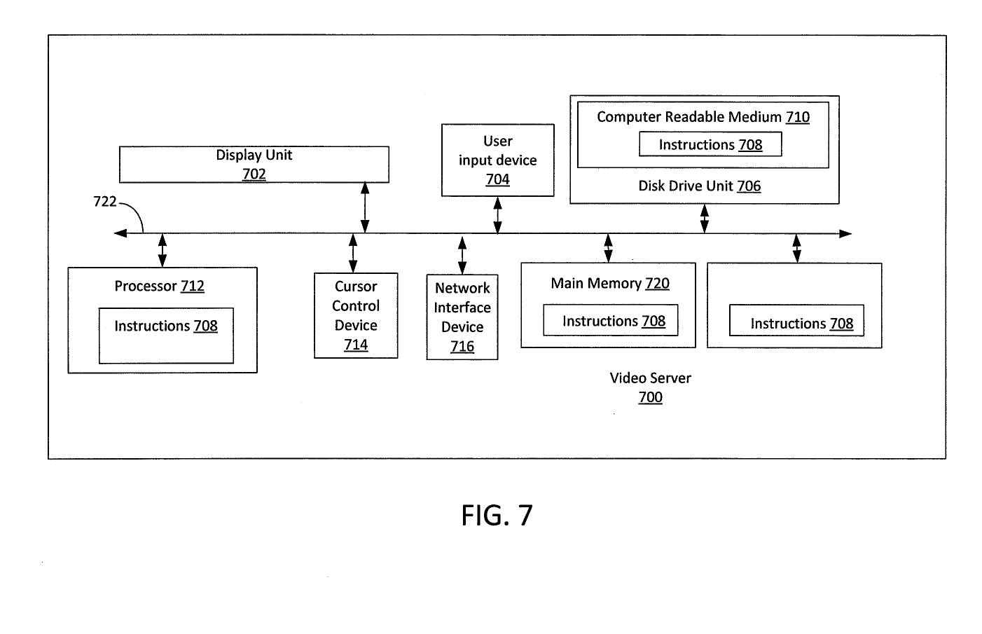

Referring now to FIG. 7, an exemplary video server 700 includes a processor 712 (such as a central processing unit (CPU), a graphics processing unit (GPU, or both), a disk drive unit 706, a main memory 720 and a static memory 718, which communicate with each other via a bus 722. The video server 700 can further include a display unit 702, such as a video display (e.g., a liquid crystal display or LCD), a flat panel, a solid state display, or a cathode ray tube (CRT)). The video 700 can include a user input device 704 (e.g., a keyboard), a cursor control device 714 (e.g., a mouse) and a network interface device 716. Network interface device 716 provide network communications with respect to network infrastructure 510

The disk drive unit 706 includes a computer-readable storage medium 710 on which is stored one or more sets of instructions 708 (e.g., software code) configured to implement one or more of the methodologies, procedures, or functions described herein. The instructions 708 can also reside, completely or at least partially, within the main memory 720, the static memory 718, and/or within the processor 712 during execution thereof by the computer system. The main memory 720 and the processor 712 also can constitute machine-readable storage media.

The architectures illustrated in FIGS. 6 and 7 are provided as examples. However, the invention is not limited in this regard and any other suitable computer system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present invention, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein. Connected to a network environment communicates over the network using the instructions 608. As used herein, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for managing distribution of video media in a group setting, comprising:
receiving at a group server a plurality of video data streams respectively generated in a plurality of video data source devices associated with a group, each said video data stream including a plurality of video frames and a plurality of metadata fields;
operating a computer processor at said group server to parse said video data streams for extracting said video frames and information comprising said plurality of metadata fields;
generating a common group metadata stream which selectively includes metadata information from each of said plurality of metadata fields;
communicating said common group metadata stream to a plurality of user equipment devices (UEDs) comprising said group;
receiving from at least one of said UEDs, a demand for a first user video stream based on said common group metadata stream;
in response to said demand, generating a first user video stream comprising said plurality of video frames included in one of said video data streams, and communicating said first user video stream to said UED from which said demand was received.

2. The method according to claim 1, further comprising generating said demand at one or more of said plurality of UEDs based on an evaluation at said UED of said group metadata stream to determine if video frames associated with one or more of said video data sources is of interest to a user.

3. The method according to claim 2, wherein said evaluating includes generating secondary metadata comprising information not directly specified by said metadata contained in said video data streams.

4. The method according to claim 2, further comprising determining based on said group metadata stream whether it is desirable to supplement said first user video stream with at least a second user video stream.

5. The method according to claim 4, further comprising identifying based on said group metadata stream, one or more second user video streams relevant to said first user video stream.

6. The method according to claim 5, wherein metadata associated with said second user video stream is not included in said group metadata stream.

7. The method according to claim 6, further comprising generating a second group metadata stream including metadata associated with said second user video stream, and communicating said second group metadata to selected ones of said UEDs in said first group.

8. The method according to claim 1, further comprising using said computer processor at said server to evaluate said plurality of metadata fields contained in each of said plurality of video data streams to determine if said plurality of video frames associated with at least one of said video data sources should be automatically communicated to one of said UEDs.

9. The method according to claim 1, further comprising generating secondary metadata comprising information not directly specified by said metadata generated at said plurality of video data source devices.

10. The method according to claim 9, further comprising communicating said secondary metadata to said UEDs in said common group metadata stream.

11. A method for managing distribution of video media in a group setting, comprising:
receiving at a group server a plurality of video data streams respectively generated in a plurality of video data source devices associated with a group, each said video data stream including a plurality of video frames and a plurality of metadata fields;
operating a computer processor at said group server to parse said video data streams for extracting said video frames and information comprising said plurality of metadata fields;
generating a common group metadata stream which selectively includes metadata information from each of said plurality of metadata fields;
communicating said common group metadata stream to a plurality of user equipment devices (UEDs) comprising said group;
receiving from at least one of said UEDs, a conditional demand for a first user video stream based on said common group metadata stream;
in response to said demand, generating a first user video stream comprising said plurality of video frames included in one of said video data streams, and communicating said first user video stream to said UED from which said demand was received.

12. The method according to claim 11, wherein said conditional demand specifies at least one processing action to be performed by said computer processor prior to said communicating said first user video stream to said UED

13. The method according to claim 12, wherein said at least one processing action comprises an analysis of a video content of at least a portion of a scene represented by at least one of said video data streams.

14. The method according to claim 13, wherein said analysis comprises identifying an occurrence of movement in said portion of said scene.

15. The method according to claim 13, wherein said portion is specified in said conditional demand.

16. The method according to claim 12, wherein said at least one processing action comprises an enhancement or modification of a video content of said first user video stream.

17. The method according to claim 11, further comprising generating said demand at one or more of said plurality of UEDs based on an evaluation at said UED of said group metadata stream to determine if video frames associated with one or more of said video data sources is of interest to a user.

18. The method according to claim 17, wherein said evaluating includes generating secondary metadata comprising information not directly specified by said metadata contained in said video data streams.

19. The method according to claim 17, further comprising determining based on said group metadata stream whether it is desirable to supplement said first user video stream with at least a second user video stream.

20. A system for managing distribution of video media in a group setting, comprising:
a group server configured to receive a plurality of video data streams respectively generated in a plurality of video data source devices associated with a group, each said video data stream including a plurality of video frames and a plurality of metadata fields;
at least one computer processor at said group server configured to:
parse said video data streams and extract said video frames and information comprising said plurality of metadata fields;
generate a common group metadata stream which selectively includes metadata information from each of said plurality of metadata fields;
communicate said common group metadata stream to a plurality of user equipment devices (UEDs) comprising said group;
receive from at least one of said UEDs, a demand for a first user video stream based on said common group metadata stream; and
in response to said demand, generate a first user video stream comprising said plurality of video frames included in one of said video data streams, and communicating said first user video stream to said UED from which said demand was received.
